(19) United States
(12) Patent Application Publication
(10) Pub. No.: US 2003/0237022 A1
(43) Pub. Date: Dec. 25, 2003

(54) System and mehod for providing a service log for processor-based devices

(76) Inventor: Jennifer J. Thayer, Greeley, CO (US)

Correspondence Address: HEWLETT-PACKARD COMPANY, Intellectual Property Administration, P.O. Box 272400, Fort Collins, CO, 80527-2400, US

(21) Appl. No.: 10/177,965

(22) Filed: Jun. 21, 2002

(51) Int. Cl. H04L 1/22

(52) U.S. Cl. 714/20

(57) ABSTRACT

A system and method for providing at least a portion of the service history of a processor-based device is provided. The present invention is directed to a system and method for providing at least a portion of the service history of a processor-based device. In one embodiment, the present invention comprises an application for providing at least a portion of the service history of a processor-based device on which the application resides. The application comprises code for receiving information relating to at least a portion of the service history of the processor-based device, code for entering the received information into a data structure, and code for providing at least one web-based page, the at least one web-based page comprising at least a portion of the information entered in the data structure.

### CROSS REFERENCE TO RELATED APPLICATIONS

This application is related to co-pending and commonly-assigned U.S. patent application Ser. No. 09/896,495, entitled “SYSTEM AND METHOD OF AUTOMATIC PARAMETER COLLECTION AND PROBLEM SOLUTION GENERATION FOR COMPUTER STORAGE DEVICES”, filed Jun. 20, 2001, the disclosure of which is hereby incorporated by reference herein.

### TECHNICAL FIELD

The present invention relates to the servicing of processor-based devices, and in one aspect to a system and method for providing a service log for processor-based devices.

### BACKGROUND

Typically, manufacturers of processor-based devices (e.g., central processing units, data storage devices, peripherals, and/or other devices including a processor or group of processors) offer customers technical support. This support may consist of technical information on the use of the device(s) or may be directed to the identification and solution of problems encountered when using the device(s).

Included among the processor-based devices for which technical support may be provided are libraries. A library is a data storage device (a library is also sometimes referred to in the art as a “juke box” or an “autochanger”). Generally, a library, like some other storage devices, is a complex hardware device that includes a plurality of storage media (e.g., tapes, cartridges, floppy disks, magnetic disks, compact discs, hard drives, or the like), as well as one or more drives operable to read data from and/or write data to the plurality of storage media. In addition, like other storage devices, a library is sometimes used for backing-up or archiving data for a computer network.

Normally, when a customer encounters a problem with one of the above-mentioned processor-based devices, the customer will notify the manufacturer or distributor that a problem exists (e.g., by calling or electronic mailing). In some instances, the customer's reporting of a technical difficulty is logged at a service center and given a service number. Oftentimes, a service person, e.g., an individual sometimes referred to in the art as a customer engineer (CE), is assigned to fix the reported problem. In some circumstances, the service person assigned to the problem is dispatched on-site to the location of the malfunctioning device(s) (in most instances, somewhere on the customer's premises). At the device location, the CE attempts to detect and repair the source of the problem reported by the customer.

The repair of processor-based devices by a service person (e.g., a CE) may be complicated by at least a few factors. One such factor is that the installed base of certain processor-based devices (e.g., sophisticated storage devices such as a library) is very small compared to that of others (e.g., PCs, printers, or scanners). Therefore, it is rare that a service person has extensive experience with troubleshooting and repairing these devices. Another factor is that certain devices, such as libraries, are very complex pieces of hardware that involve a multitude of moving parts that are difficult to diagnose even if a service person has substantial experience with such devices.

Moreover, the repair of certain processor-based devices, including but not limited to libraries, often involves multiple service visits by multiple service persons. For instance, a particular service person, such as a CE, may be dispatched to the customer's site the first time the customer reports a particular problem. At the customer's site, the service person makes and tests repairs to the device. In some circumstances, at some point during the repair process, the device appears to properly function. Therefore, the service person, thinking the reported problem has been alleviated, leaves the device location.

However, in some circumstances, at some later time, the problem reappears and a second call is made to the service center. As a result, a service person, such as a CE, is again dispatched to fix the problem. However, it is unlikely that the same service person who serviced the device the first time is dispatched to the customer's site the second time. For instance, service department turnover or a service center policy whereby a service order is assigned to the first available service person may mean that the individual who was originally dispatched to repair the device is not available for a subsequent visit. Furthermore, even if the same service person was dispatched in response to the second call, the likelihood that the person remembers the specifics of the previously attempted repairs is low considering that the person has probably serviced a multitude of other devices since the person was last dispatched to service this device. Therefore, most likely, the service person being dispatched to the customer's site in response to the second call has little knowledge or recollection of the service history of the device. Thus, any debugging and/or repair work performed by the service person is done on an ad-hoc basis.

For example, suppose a representative of a customer calls the service center complaining that a digital linear tape (DLT) cartridge is stuck in a DLT tape drive of one of the customer's libraries. As a result, a first CE is dispatched to the customer's site where the library is located. At the site, the first CE swaps one or more of the drives of the library. At the time, the swapping of drives appears to have fixed the problem. Therefore, the CE, thinking that the problem has been solved, closes the service call. However, the problem reappears a week later and a customer representative calls the service center a second time. Not knowing that one or more drives had previously been swapped with no success, the second CE dispatched performs the same repairs as the first CE. Thus, rather than contemplating that perhaps something other than the drives may be the root of the problem, the second CE repeats the measures taken by the first CE. Therefore, the root problem remains uncorrected, even after the visit by the second CE.

In situations where multiple site visits have been made with little or no success, most often the service call is then escalated to the next level of service support (escalation referring to the scenario where a service call is not capable of being handled by one level of support, and therefore must be handed off to the next higher level of support), and the next, until the division that designed the storage device may even be ultimately involved. Normally, by this point, the customer is upset because a significant amount of time and resources have been expended, yet the device remains unfixed. Likewise, the service personnel are frustrated that the device problem(s) remain unsolved.

### BRIEF SUMMARY OF THE INVENTION

The present invention is directed to a system and method for providing at least a portion of the service history of a processor-based device. In one embodiment, the present invention comprises an application for providing at least a portion of the service history of a processor-based device. The application comprises code for receiving information relating to at least a portion of the service history of the processor-based device on which the application resides, code for entering the received information into a data structure, and code for providing at least one web-based page, the at least one web-based page comprising at least a portion of the information entered in the data structure.

### BRIEF DESCRIPTION OF THE DRAWINGS

FIG. 1 depicts an exemplary embodiment of a customer network environment;

FIG. 2 depicts an exemplary embodiment of the architecture of a single level of a library;

FIG. 3 depicts an exemplary flow diagram of interaction between an individual, an embodiment of a web server, and an embodiment of a web-based page hosted thereby;

FIG. 4 depicts a high-level schematic diagram of an exemplary embodiment of a remote management card;

FIG. 5 depicts an exemplary arrangement of possible options for a service person, or other individual, to access an exemplary service log in accordance with the present invention;

FIG. 6 depicts an exemplary embodiment of an overview page of a service log in accordance with the present invention as viewed through an exemplary web browser; and

FIG. 7 depicts an exemplary embodiment of an add entry page of a service log in accordance with the present invention as viewed through an exemplary web browser.

### DETAILED DESCRIPTION

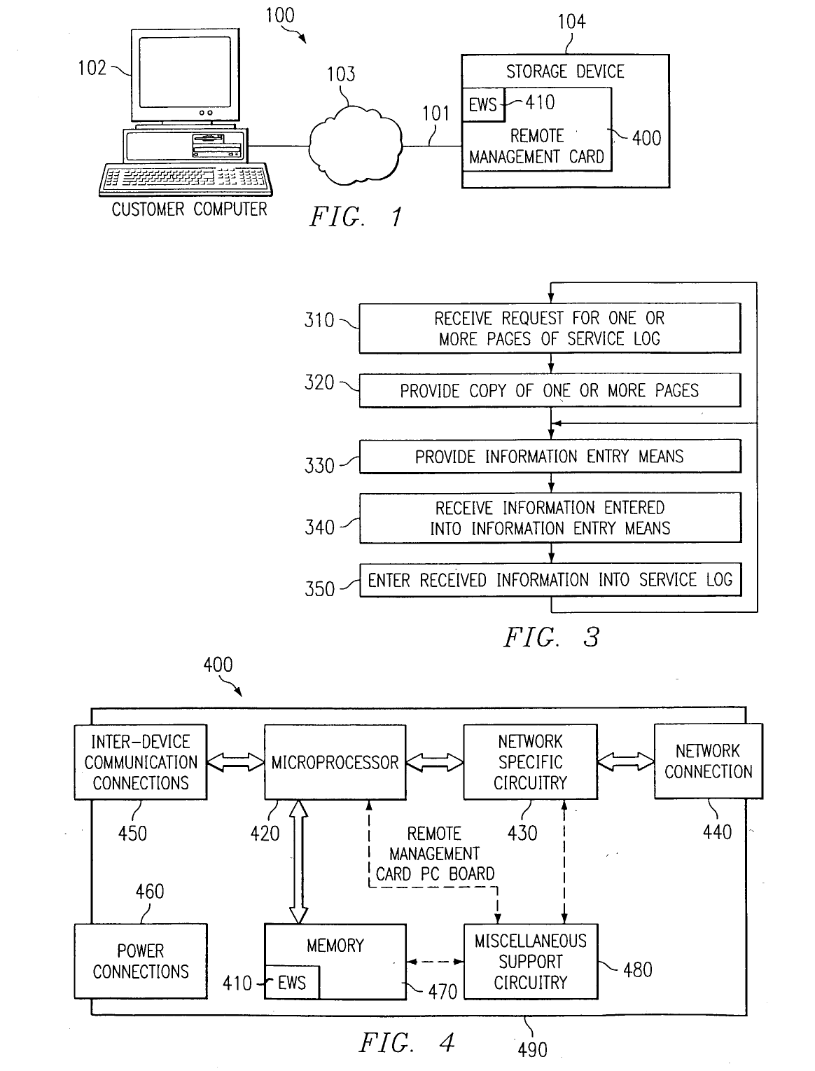

FIG. 1 provides an exemplary embodiment of customer network environment 100 (customer, in this example, being the user of a processor-based device incorporating a web server discussed in detail below). In the embodiment of FIG. 1, customer network environment 100 comprises data network 103. Data network 103 may be any one or a combination of numerous data networks known in the art, or later developed, to include a telephone network, an Ethernet network, an Intranet network, a wide area network (WAN), a local area network (LAN), a metropolitan area network (MAN) and/or a fibre channel network. Data network 103 may be implemented utilizing any number of communication mediums and protocols, wireline and/or wireless.

In addition to data network 103, customer network environment 100 comprises at least one customer computer device (e.g., customer computer device 102). Customer computer device 102 may be communicatively coupled to data network 103 by one or more means, now known or later developed, for communicatively coupling a computer device to a data network, to include both wired and wireless connections, as well as some combination thereof. For purposes of this disclosure, a computer device is any suitable processor-based device through which an individual may access a web-based page (described in greater detail below). Non-limiting examples of customer computer device 102 include a personal computer (PC), personal digital assistant (PDA), personal communications system (PCS), etc.

In one embodiment, in addition to the one or more customer computer devices, customer network environment 100 comprises other processor-based devices, such as a storage device (e.g., storage device 104). Non-limiting examples of the storage device(s) that may be included in network environment 100 are libraries, hard drives, disk drives, compact disc (CD) drives, high capacity disk drives, JBODs (Just a Bunch Of Disks), tape drives, disk arrays, stackers, drivers, warehouses, and/or other data storage devices now known or later developed. In some embodiments, storage device 104 is used to back up or archive data for customer network environment 100.

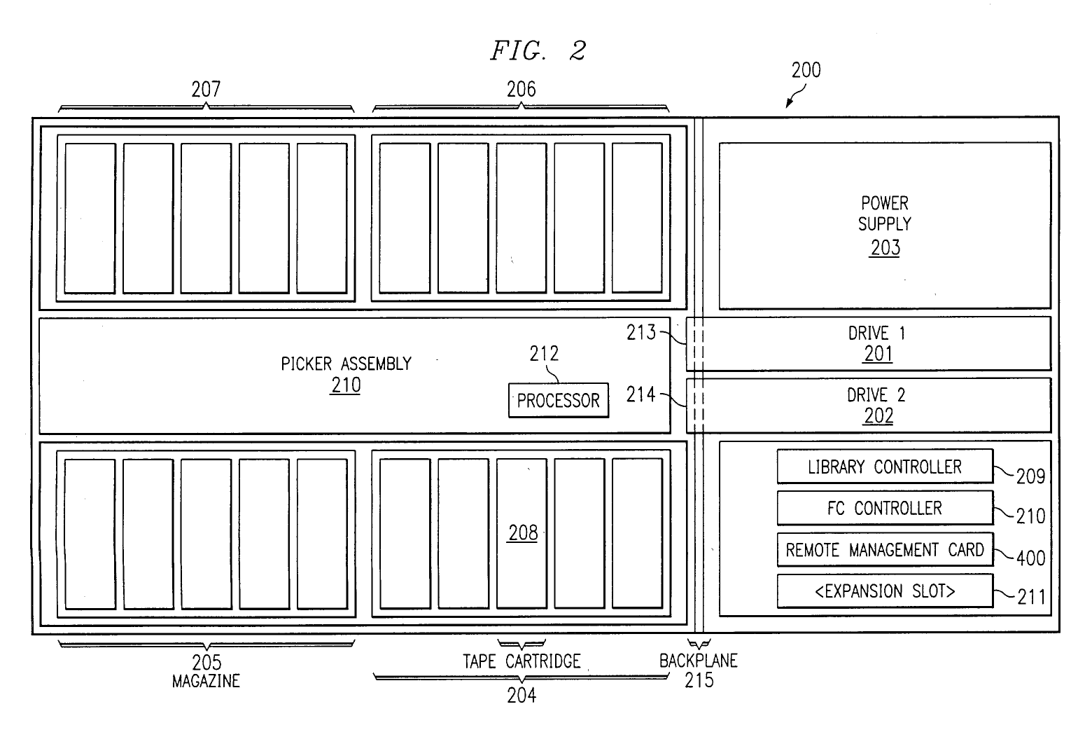

As mentioned, storage device 104 may be a library. FIG. 2 provides a top-view image of an exemplary arrangement of a single level of an embodiment of library 200. Library 200 may comprise any number of levels depending upon the customer's data storage needs. Moreover, levels may be easily added to or removed from library 200 to accommodate any changes in the customer's data storage needs.

In the illustrated embodiment, library 200 comprises one or more drives, such as drive 201 and drive 202. Drives 201 and 202 may comprise tape drives. Library 200 further comprises one or more magazines (e.g., magazines 204, 205, 206, and 207) for storing and/or supplying storage media (e.g., tape cartridges, magnetic disks, etc.). Each of the magazines of library 200 may comprise a plurality of tape cartridges (e.g., tape cartridge 208 of magazine 204). In library 200, computer data is read from and/or written to a storage medium by one of the drives of library 200 (e.g., drive 201 and/or drive 202). Power supply 203 provides the power required for these actions, as well as the other operations of library 200.

Furthermore, in the illustrated embodiment, each of drive 201 and drive 202 is situated in a respective drive can that comprises a drive board (e.g., drive board 213 and drive board 214). Each drive board may comprise at least one processor.

Also in the illustrated embodiment, library 200 comprises picker assembly 210. Picker assembly 210 (also sometimes referred to in the art as a picker) may be an electro-mechanical system that moves the storage media in and out of drives 201 and 202 when commanded, e.g., via a front panel of the library (not shown) and/or a command provided to the library from a computer device communicatively coupled thereto (e.g., a small computer system interface (SCSI) command). In some embodiments, there is only one picker assembly per library. In such an instance, if there is more than one level in the library, the picker maneuvers between levels to service the entire library. In one embodiment, picker assembly 210 comprises at least one processor (e.g., processor 212).

Library 200 may also comprise backplane 215. Backplane 215 may comprise a printed circuit board having multiple connectors for connecting the elements of a particular level of library 200 together (comparable to a motherboard in a personal computer). In one embodiment, the connectors of backplane 215 enable power to be supplied to the elements of a particular level of library 200 (e.g., drives; sensors; card cage cards, such as a remote management card (described below), a fibre channel card, a library controller card, etc.), as well as to facilitate communication between elements. Backplanes located on different levels of library 200 are typically communicatively coupled to one another via jumper cables, so as to facilitate communication between controller boards of different levels.

As mentioned, in some embodiments, library 200 comprises at least one card. For example, in one embodiment, library 200 comprises library controller card 209 and fibre channel controller card 210 (e.g., if library 200 supports fibre channel). In some embodiments, there is one library controller card per level. Moreover, there may be one fibre channel control card for every level of library 200 on which at least one drive is located. In the illustrated embodiment, library 200 also comprises expansion slot 211. A library may comprise one or more expansion slots so as to facilitate expansion of the capabilities of library 200. Moreover, library 200 may also comprise remote management card (RMC) 400 (discussed in greater detail below). Each of the cards of library 200 may comprise a processor.

It will be appreciated by one of ordinary skill in the art that the elements of library 200 depicted in FIG. 2, as well as the number of elements, their dimensions, their arrangements, etc., are by way of example only. Library 200 may comprise elements other than those depicted in FIG. 2, a greater or fewer number of elements than those depicted in FIG. 2, as well as different dimensions and different arrangements than those depicted in FIG. 2. For example, library 200 may comprise more or fewer drives, magazines, and/or storage media than that which is depicted in FIG. 2. Furthermore, in one embodiment, library 200 does not comprise fibre channel controller card 210. It will be appreciated that controller cards other than those depicted, e.g., a SCSI controller card, may be included in library 200.

Referring back to FIG. 1, in addition to or in lieu of storage devices, the earlier-mentioned other processor-based devices of network environment 100 may comprise input and/or output devices, such as displays, speakers, keyboards, pointing devices, printers, etc.

In one embodiment, at least one of the processor-based devices of network environment 100 comprises a remote management card (RMC). In the illustrated embodiment, storage device 104 comprises remote management card (RMC) 400. Also in the illustrated embodiment, RMC 400 is communicatively coupled to data network 103 via connection 101. RMC 400 may be communicatively coupled to data network 103 via the communicative coupling between data network 103 and the processor-based device in which RMC 400 is integrated (e.g., the communicative coupling between data network 103 and storage device 104) or via a separate communicative coupling. Furthermore, similar to customer computer device 102, RMC 400 may be communicatively coupled to data network 103 by one or more means, now known or later developed, for communicatively coupling a device to a data network, to include both wireline and wireless connections, as well as some combination thereof. As a non-limiting example, connection 101 may be a 10/100 Base-T Ethernet connection.

Remote management card 400 may comprise a printed circuit board (PCB) with networking capability that may be integrated with a processor-based device (e.g., storage device 104). In one embodiment, RMC 400 is integrated with a device by inserting RMC 400 into a card cage of the processor-based device. In some embodiments, only one RMC is integrated into a particular processor-based device.

In operation, RMC 400 is an information manager that collects and packages information regarding the device with which RMC 400 is integrated. RMC 400 may also enable an individual(s) to manage and/or monitor the device with which the RMC is integrated from any location on a data network to which the device is communicatively coupled (e.g., data network 103), to include locations remote from the processor-based device. The “remoteness” in terms of distance is not critical to the invention, as the “remote location” may be in the same room as or provided along with the processor-based device.

In one embodiment, such remote management and/or monitoring is facilitated, at least in part, by a web server of RMC 400 (e.g., embedded web server (EWS) 410). EWS 410 may enable an individual(s) to receive and/or provide information relating to the device with which RMC 400 is integrated. In some embodiments, EWS 410 provides such information via web-based pages hosted by the web server. Note that for purposes of this disclosure, a web-based page refers to structured data available from a central location, in some embodiments, accessible over any medium (wireline and/or wireless), and available to multiple potential users.

In one embodiment, when RMC 400 is communicatively coupled to data network 103, EWS 410 and/or the web-based pages hosted thereby are assigned an IP address or addresses through which EWS 410 and/or the web-based pages hosted thereby may be accessed, communicated with, executed, etc. The IP address may be autonomously assigned, e.g., by a dynamic host configuration protocol (DHCP) server of network environment 100. In an alternative embodiment, the IP address is manually assigned/configured, e.g., through a front panel of the processor-based device.

Furthermore, EWS 410 and/or the web-based pages hosted thereby may exist as running processes or services on RMC 400. When such running processes or services are implemented via executable instructions, various elements of EWS 410 and/or the web-based pages hosted thereby are in essence the application, code, etc., defining the operations of such elements. EWS 410 and/or the web-based pages may be implemented in any programming language, now known or later developed, to include C, C++, Visual Basic, Hypertext Markup Language (HTML), Java, JavaScript, Server-Side, etc., or a combination thereof. Alternatively, other mark-up languages and formats may be used without deviating from the spirit of the invention. The executable instructions or code implementation of EWS 410 and/or the web-based pages hosted thereby may be obtained from a readable medium (e.g., read only memory (ROM), such as Erasable Programmable Read Only Memory (EPROM); random access memory (RAM), such as dynamic random access memory (DRAM); flash memory or any other medium that may store or transfer information).

Non-limiting examples of the information that may be provided by the web-based pages hosted by EWS 410 include performance data, error information, status data for the processor-based device incorporating RMC 400 (e.g., status data for drives, storage media, and/or the overall device itself); device configuration information and operations; internal logs, to include media logs (e.g., drive media logs), error reporting logs, and comprehensive error logs; device firmware downloads; diagnostic information; capacity information and support information; network traffic relating to the device; or some combination thereof. In addition to or in lieu of the above, the web-based pages may provide information not directly related to the operation of the device, such as contact information and/or device location information. The above information may be useful in the diagnosis and repair of a problem(s) that occurs with the processor-based device.

One particular example of a web-based page that may be hosted by EWS 410 is what may be referred to as a report page. In one embodiment, a report page acquires all of the internal logs and configuration information that the device incorporating RMC 400 may autonomously provide and displays it all together in a form that may be useful to, e.g., service personnel (such as a CE) servicing the device. In one embodiment, a service person may use this support information for debugging purposes.

Additionally, a service log is included among the web-based pages hosted by EWS 410. The service log may comprise at least one web-based page whereby service personnel (e.g., a CE) and/or other individuals may review and/or enter information relating to at least a portion of the service history of the device on which the service log resides. In one embodiment, the service personnel or other individuals may then use the service history information provided by the service log to help in the diagnosis and repair of problems affecting the device.

A flow diagram illustrating the interaction between an individual (e.g., a service person), an embodiment of EWS 410, and an embodiment of the service log that may be hosted thereby is provided in FIG. 3. In FIG. 3, a service person or other individual communicates a request for at least one of the web-based pages of the service log to EWS 410 using a computer device (box 310). This computer device may be any suitable processor-based device through which an individual may access a web-based page. Furthermore, this computer device may be situated at a location remote from EWS 410. Potential means by which such a request may be communicated is described in greater detail below.

In response to the request, EWS 410 provides a copy of at least one of the web-based pages of the service log to the computer device through which the earlier-mentioned request was made (box 320). In doing so, EWS 410 may provide the service person or other individual with at least a portion of the service information previously entered into the service log, if such service information was previously entered. In one embodiment, the information provided also comprises information not relating to the service history of the device. For example, the information provided may comprise the location of the device, the owner of the device, a contact person, etc.

In one embodiment, one or more of the pages provided to the computer device comprises an information entry means whereby the service person or other individual may enter information into at least one of the provided pages (box 330). In one embodiment, the information entry means is provided in response to a request from the service person or other individual. The information entry means may be any means, now known or later developed, for entering information into a web-based page.

The service person or other individual enters service information into at least one of the provided pages, e.g., via the information entry means. At some point after such information is entered, at least a portion of this entered information is communicated to and received by EWS 410 (box 340). EWS 410 (in some embodiments, automatically) enters at least a portion of the received information into the service log hosted thereby (e.g., a data structure of the service log) (box 350).

Before, simultaneously with and/or after the entered information is received and stored by EWS 410, EWS 410 may again provide an information entry means whereby the service person or other individual may enter information into at least one of the provided pages (i.e., enables a cycle of information entry). This information entry means may be the same means by which the earlier-discussed information was entered and/or a different information entry means.

In the illustrated embodiment, at some point after some or all of the received information is entered into the service log, the same service person or another individual requests one or more of the web-based pages of the service log (returning to box 310). The request may be made using the same computer device as before or a different computer device. Furthermore, in some embodiments, this request may be made from the same location as that above or a different location (in some embodiments, a different remote location). In response to this request, EWS 410 again provides a copy of one or more of the web-based pages of the service log. In one embodiment, the information provided comprises at least a portion of the information received at box 340. Furthermore, one or more of these web-based pages may comprise the earlier-discussed information entry means.

FIG. 4 depicts a high level schematic diagram of an exemplary embodiment of RMC 400. In the illustrated embodiment, RMC 400 comprises network connection(s) 440, inter-device communication connection(s) 450, and power connection(s) 460. Network connection(s) 440 may allow for communicatively coupling between RMC 400 and a data network (e.g., for coupling to connection 101, that, in turn, is coupled to network 103). Similarly, power connection(s) 460 may allow RMC 400 to be operatively coupled to the power and/or ground plane(s) of the processor-based device incorporating RMC 400. Furthermore, inter-device communication connection(s) 450 may allow for communicatively coupling between RMC 400 and other components of the device incorporating RMC 400.

In addition or in the alternative, RMC 400 may comprise microprocessor 420, which may be any general purpose processor or group of processors. In one embodiment, microprocessor 420 is communicatively coupled to inter-device communication connection(s) 450 and/or memory 470. Memory 470 may be any medium that may store or transfer information.

The earlier-discussed executable instructions or code implementations of EWS 410 and/or the web-based pages hosted thereby (e.g., the service log) may reside on memory 470 (as illustrated in FIG. 2). The devices that may execute EWS 410 and/or the web-based pages hosted thereby are not restricted by the architecture of RMC 400, so long as they support the inventive operations as described herein.

In one embodiment, RMC 400 comprises circuitry besides that mentioned above. For example, in one embodiment, RMC 400 comprises network-specific circuitry 430. Network-specific circuitry 430 may be coupled to microprocessor 420 and/or network connection(s) 440. The components of network-specific circuitry 430 relates to the data network to which RMC 400 is to be communicatively coupled. For example, if RMC 400 is to be coupled to a fibre channel network, network specific circuitry 430 comprises fibre channel-related circuitry (e.g., a Hewlett-Packard Tachyon™ chip). Other non-limiting examples of components of circuitry 430 are an Ethernet transceiver chip, conversion circuitry (such as packetizers and depacketizers), filters, etc.

Furthermore, in some embodiments, RMC 400 also comprises miscellaneous support circuitry 480. Support circuitry 480 is communicatively coupled to at least one of the other components of RMC 400 (e.g., microprocessor 420, network specific circuitry 430, and/or memory 470). In one embodiment, support circuitry 480 supports the main functional chips of RMC 400 (e.g., sets registers, etc.). Non-limiting examples of such support circuitry include one or more resistors (e.g., for pull-ups and pull downs), power supplies, regulators, gates, capacitors, inductors, diodes, transistors, etc.

In some embodiments, all of the above elements of RMC 400 are integrated with printed circuit board 490.

It will be appreciated that the elements of RMC 400, as well as the arrangement of such elements, depicted in FIG. 4 are by way of example only, for RMC 400 may comprise a fewer or greater number of elements than that which is depicted in FIG. 4, as well as a different arrangement of elements than that which is depicted. Moreover, elements not depicted in FIG. 4 may be included in RMC 400. For example, in one embodiment, rather than power connection(s) 460, RMC 400 may comprise its own power source (e.g., a battery).

As is the case with all electronic devices, technical problems may occur with respect to a processor-based device included in customer network environment 100. As discussed previously, in such circumstances, a service person (e.g., a CE) may be assigned to diagnose and repair the problem(s). In one embodiment, with the service log of the present invention, the testing and repairs typically performed by the service person or other individual may be done with the help of at least a portion of the service history of the device.

For example, by accessing the service log, the service person assigned to repair the reported problem may review information relating to at least a portion of the previous service work performed on the processor-based device (if any such information was previously entered). Therefore, the service person(s) may learn of previous unsuccessful attempts to solve the problem(s) the service person(s) was assigned to correct. Thus, when attempting to diagnose and/or repair the problem(s) to which the service person is assigned, rather than repeat the steps involved in any previously unsuccessful efforts reported in the service log, the service person may instead take a different course of action towards the repair of the device (e.g., look for a different source of the problem(s) than previously considered, replace different parts of the device, etc.). In one embodiment, at the very least, the service person does not repeat such previously unsuccessful efforts without some diligent investigation into the necessity of repeating such unsuccessful action(s). In addition, the service person(s) may enter information into the service log relating to the person's own servicing work with respect to the device so that a service person subsequently assigned to repair the device will know of the present service person's efforts.

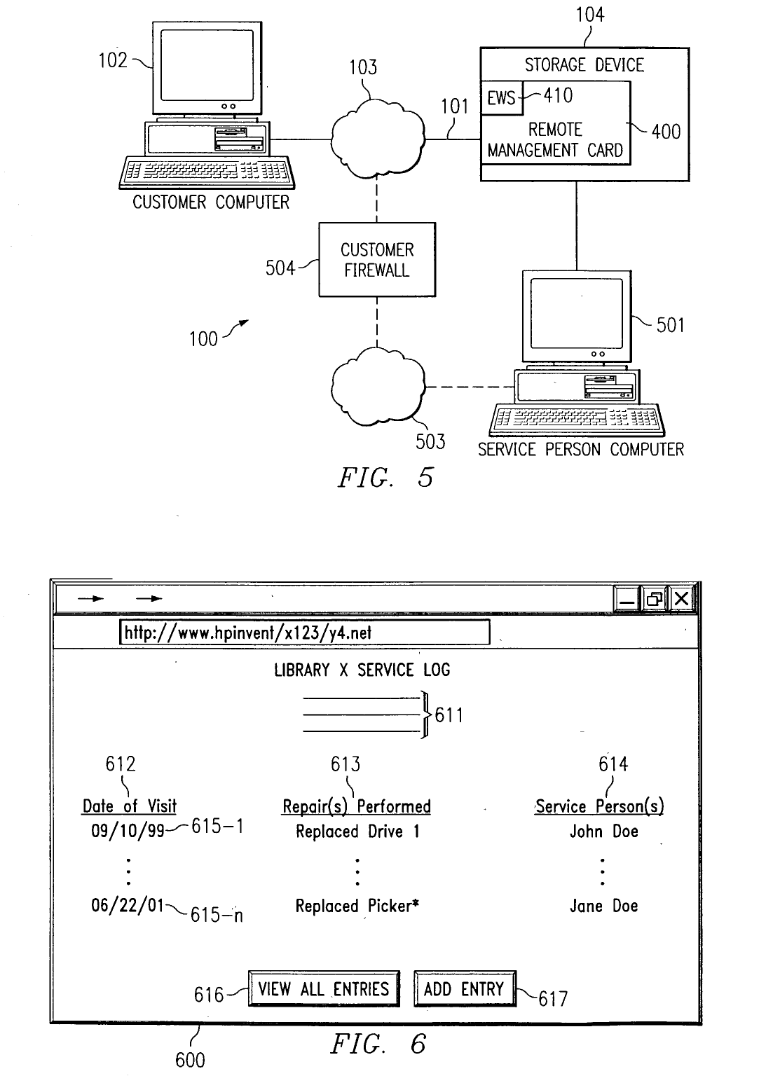

As discussed above, in one embodiment, an individual accesses the service log by requesting and receiving a copy of one or more of the web-based pages of the service log from EWS 410. FIG. 5 provides an exemplary embodiment of potential options for an individual to request and receive a copy of one or more of the web-based pages of the service log, as well as one or more other pages hosted by EWS 410.

In some embodiments, a service person, as well as other individuals, may access (i.e., request and receive a copy of one or more of the web-based pages of) the service log using a computer device communicatively coupled to a data network to which RMC 400 is also communicatively coupled (e.g., data network 103). For example, in the illustrated embodiment, a service person (e.g., a CE), may access the service log of storage device 104, as well as the other web-based pages hosted by EWS 410, using any one of the customer computer devices communicatively coupled to data network 103 (e.g., customer computer device 102).

Furthermore, in one embodiment, rather than accessing the service log using one of the customer's computer devices, as another option, the service person (e.g., the CE) may access the service log via the service person's own computer device (e.g., service person computer device 501 of FIG. 5). In some embodiments, service person computer device 501 is a portable computer device, such as a laptop or personal digital assistant (PDA), that the service person brings to the customer site on the service person's service visit. In one of these embodiments, the service person may access the web-based pages hosted by EWS 410, to include the service log, by communicatively coupling computer device 501 directly to storage device 104 using, e.g., an Ethernet crossover cable (in some embodiments, after storage device 104 has been disconnected from network environment 100).

However, rather than being with the service person on-site, service person computer device 501 may be located at the service person's place of business (or anywhere else for that matter). For example, service person computer device 501 may be part of a service center computer system. In one embodiment, to access one or more web-based pages hosted by EWS 410, computer device 501 is communicatively coupled to data network 103, e.g., through data network 503. Data network 503 may be any data networks, now known or later developed. Moreover, like data network 103, data network 503 may be implemented using any number of wireline or wireless communication mediums and protocols. Service person computer device 501 may be communicatively coupled to data network 503 by one or more means, now known or later developed, for communicatively coupling a device to a data network, to include wired and/or wireless connections. In some embodiments, as part of the above, EWS 410 pushes copies of the web-based pages through customer firewall 504 to computer device 501.

Regardless of the particular manner in which an individual communicatively couples to EWS 410, in one embodiment, the individual accesses the web-based pages of EWS 410 via a web browser running on a computer device that is being used by the individual (e.g., customer computer device 102, service person computer device 501, service center computer system 502, etc.). Acceptable web browsers for viewing the web-based pages of EWS 410 include all web browsers now known or later developed.

In one embodiment, a service person or other individual accesses the web-based pages of EWS 40 via a web browser. In an alternative embodiment, rather than accessing the web-based pages hosted by EWS 410 through a web browser, the web pages are instead accessed through a system administration application (e.g., HP OpenView Network Node Manager®) or some other higher level network management and/or monitoring software. In one of these embodiments, plug-ins or other related software applications are integrated into the above mentioned administrative applications, thereby allowing individuals via the administrative application(s) to request and receive one or more of the web-based pages hosted by EWS 410.

In some embodiments, regardless of whether access to the web-based pages hosted by EWS 410 is attempted via a web browser or some other means, before any copies of the web-based pages are provided by EWS 410, a log-in page appears whereby the service person, or other individual, is prompted to provide a log-in identifier and/or password before gaining access to any of the web-based pages, to include the service log. In some embodiments, the password for accessing the service log, or any of the other web-based pages hosted by EWS 410, is a service password. A service password may be a password assigned by the service center or other unit affiliated with the manufacturer and/or distributor. In addition to the above, a service password may be used to enable the adding and/or removing of passwords for access to the service log and/or the other web-based pages. In addition to or in lieu of a service password, the service log, or any of the other web-based pages hosted by EWS 410, may be accessed using an administrative password. An administrative password may be a password set by the customer to prevent modification of device settings by an unauthorized individual. Moreover, in addition to the above log-in page, the service person, or other user, may be required to enter an additional log-in identifier and/or password at another web-based page before being granted access to yet another of the web-based pages.

After satisfying the log-in requirement for the service log, if one exists, the service person(s) or other individual(s) may access an overview page of the service log. FIG. 6 depicts an overview page (or proposed first page) 600 of an exemplary embodiment of a service log when viewed through the graphical user interface (GUI) of an exemplary web browser. Overview page 600 may be the “home” page or initial page of the web-based page(s) comprising the service log.

In the embodiment of FIG. 6, overview page 600 comprises three (3) columns; particularly, first column 612 entitled “Date of Visit”, second column 613 entitled “Repair(s) Performed”, and third column 614 entitled “Service Person(s)”. Accordingly, each of entries 615-1 to 615-n of overview page 600 provides the date a particular service visit was made to a particular processor-based device (e.g., storage device 104), a brief description of at least one of the repairs performed on that visit (if any repairs were performed at all), and the name of at least one of the service persons who performed the service work. For example, entry 615-1 notifies the viewer that a service visit was made on Sep. 10, 1999, that at least one of the repairs performed on that date was the replacement of a drive, and that at least one of the service persons (e.g., CEs) who performed the repair was John Doe.

With respect to column 612, it will be appreciated that the date on which the service visit was made may be expressed in a manner other than that shown in FIG. 6. For example, rather than “Sep. 10, 1999”, entry 615-1 may instead read “Sep. 10, 1999” or “Sep. 10, 1999” or some alternative means for expressing a date.

Similarly, it will be appreciated that the brief description(s) of the at least one repair performed during a service visit may be provided in a manner other than that depicted in column 613 of FIG. 6. For example, there may be a limit to the number of characters that may be included in the brief description portion of an entry of overview page 600, and therefore any characters of the repair(s) description provided beyond the maximum character allotment will not be shown in column 613. Moreover, in some embodiments, in situations where more than one repair was performed on a particular visit, only a brief description of one of the repairs performed is provided in the entry relating to that particular visit. However, an indicator appears along with the description (e.g., an asterisk) notifying the viewer that more than one repair was performed on that particular service visit (e.g., entry 615-n). In addition, in circumstances where no repairs were performed on a particular visit, descriptions such as “None” or “N/A” may be provided in column 613.

Likewise, with respect to column 614, the name(s) of the service person(s) may be provided in a form other than that depicted in FIG. 6. For example, for a given entry, rather than providing the full name of at least one service person who performed the repair(s) (as shown in FIG. 6), the initials of at least one service person or all service persons who performed the repair(s) may be provided.

In some embodiments of the present invention, the information provided in each of entries 615-1 to 615-n of overview page 600 represents a smaller portion of an available larger collection of information that relates to the service visit that is the subject of the particular entry. In some of these embodiments, overview page 600 provides some summation of at least a portion of the service history of the processor-based device (e.g., storage device 104), while at the same time provides a means to access additional information about the service history of the device, if such additional information is desired by the service person, etc.

For example, in some embodiments, at least one (in one embodiment, each) entry of overview page 600 (i.e., each of entries 615-1 to 615-n) may serve as a link (e.g., a hypertext link) to a corresponding more detailed log entry page, the more detailed log entry page containing information of which the information provided in the entry of page 600 is only a part. In one such embodiment, upon the selection of a particular entry of overview page 600 by the service person or other individual, the corresponding detailed log entry page appears in the same display of the GUI as overview page 600 previously appeared. In an alternative embodiment, the corresponding detailed log entry page appears in a separate display. The arrangement/format of these more detailed log entry pages will be described in greater detail below.

Also, in one embodiment, in addition to being able to view at least one detailed log entry page through selecting its corresponding entry in overview page 600, all of the detailed service log entries may be viewed by selecting “view all entries” button 616 of overview page 600. Upon the selection of button 616, a compilation of all detailed log entries appears in the same display in which overview page 600 previously appeared (in an alternative embodiment, the compilation appears in a separate display). Such a compilation may be scrollable.

In addition to the information provided in columns 612, 613, and 614, in one embodiment, service log 600 also comprises miscellaneous information portion 611. Within miscellaneous information portion 611, information such as the location of the storage device, contact information for the storage device, general contact information for the customer, and/or other information not directly related to service work performed on the device may be provided.

It will be appreciated by one of ordinary skill in the art that the format of overview page 600 is by way of example only, for overview page 600 may have various configurations. For example, columns other than those provided in FIG. 6 may be included in overview page 600. For instance, overview page 600 may comprise a column providing information relating to the problem(s) reported by the customer. Moreover, a fewer or greater number of columns may be included in overview page 600. For example, column 614 may be absent from an embodiment of overview page 600. In addition, titles other than those provided for columns 612, 613, and 614 in FIG. 6 may appear in overview page 600. Furthermore, in one embodiment, at least a portion of the format of overview page 600 may be configured by the customer or service person.

In some embodiments, a service person, or other individual, may add a new entry to overview page 600 (and hence, the service log) by requesting the earlier-mentioned information entry means. In one embodiment, this is done by selecting add entry button 617 of overview page 600. Upon selecting button 617, an add entry page appears. The add entry page may appear in the same display of the GUI in which overview page 600 previously appeared or the add entry page may appear in a separate display.

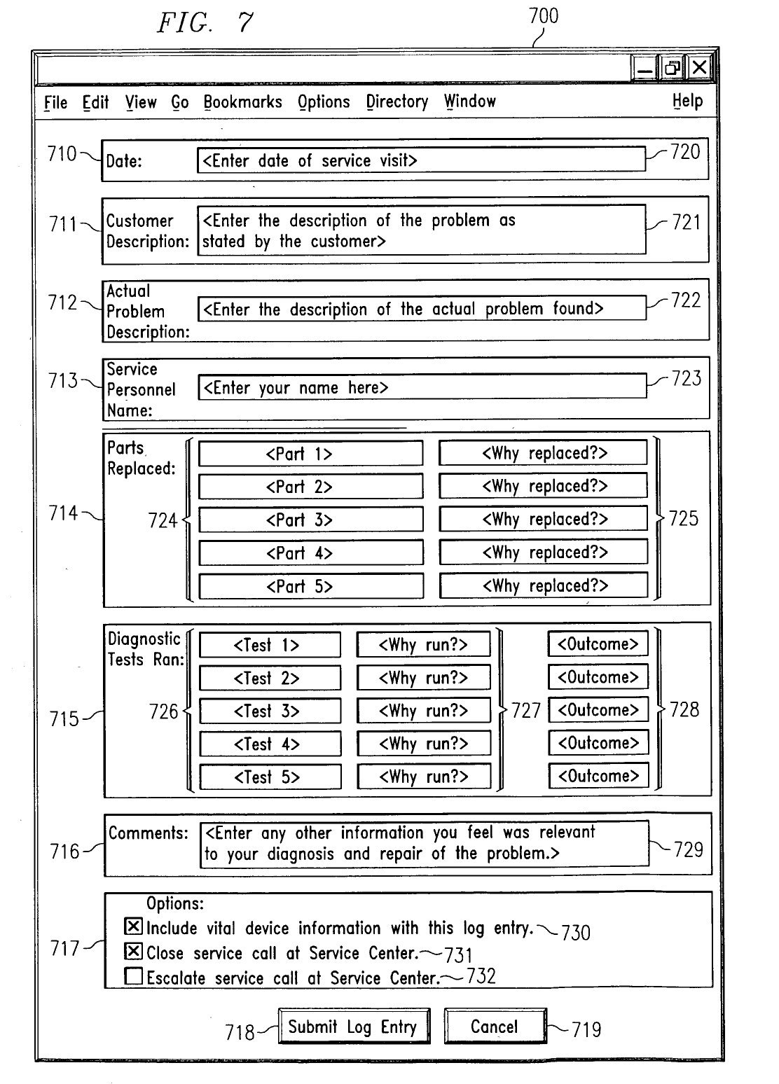

FIG. 7 provides an exemplary embodiment of add entry page 700 (also referred to as detailed log entry form 700) when viewed through the graphical user interface (GUI) of an exemplary web browser. Add entry page 700 may comprise a template of data fields/cells to be filled with information relating to the servicing of a processor-based device (e.g., storage device 104). Similar to earlier discussions, such information may be entered into these fields via one or more means, now known or later developed, for entering information into a web-based page, non-limiting examples of which include typing data into a field, scrolling through a pull-down menu and selecting a particular item listed in the menu, and/or the like.

In the illustrated embodiment, add entry page 700 comprises “date” portion 710 wherein the date a service visit was or is being made may be entered into “date” field 720. In addition to “date” field 720, “date” portion 710 may comprise a “time of visit” field and/or a “visit duration” field (not shown).

Furthermore, prior to the entry of any data into field 720, “date” field 720 may display instructional information to aid in the completion of the detailed log entry form (e.g., the “<Enter date of service visit>” instruction shown in FIG. 7). Other fields of add entry page 700 may also comprise such instruction information (as illustrated in FIG. 7) Such instructional information appearing in field 720 and/or other fields of add entry page 700 may disappear from their respective fields as soon as any information is entered into the respective fields.

In addition or in the alternative of date portion 710, add entry page 700 may comprise “customer description” portion 711 wherein the description of the problem(s) occurring with the processor-based device (e.g., storage device 104) as reported by the customer may be entered into “customer description” field 721. There may be more than one customer description field so that each particular problem reported may be entered into a separate field.

In the illustrated embodiment, add entry page 700 also comprises “actual problem description” portion 712 wherein a description of the actual problem found by the service person(s) may be entered into “actual problem” field 722. There may be more than one actual problem field so that each problem found may be entered into a separate field.

Add entry page 700 may also comprise “service personnel name(s)” portion 713 wherein one or more of the names (or, in one embodiment, the initials) of the service personnel who went on the service visit and/or performed the repair(s) made to the processor-based device may be entered into “service personnel” field 723.

Furthermore, in one embodiment, add entry page 700 further comprises “parts replaced” portion 714 wherein information such as the part(s) of the device replaced during the service visit, as well as the reason(s) for replacing the part(s), may be entered. In the embodiment of FIG. 7, “parts replaced” portion 714 comprises “parts” fields 724 and corresponding “reasons replaced” fields 725. Although in FIG. 7, the parts replaced and reasons for replacement are entered into separate fields, in one embodiment, at least one part replaced and the reason(s) for its replacement are entered into the same field.

Also in the illustrated embodiment, add entry page 700 comprises “diagnostic tests ran” portion 715 wherein information such as the diagnostic test(s) run during a service visit, the reason(s) the test(s) was (were) run, and the outcome of the test(s) may be entered. In the embodiment of FIG. 7, “diagnostic tests ran” portion 715 comprises “test” fields 726, “reasons run” fields 727, and “outcome” fields 728. Although in FIG. 7, the diagnostic test(s) run, the reason(s) for the test, and the outcome(s) of the test(s) are each entered into separate fields, in one embodiment, at least one diagnostic test run, the reason(s) for the test, and the outcome(s) of the test are entered into the same field.

The illustrated embodiment also comprises “comments” portion 716. “Comments” portion 716 may contain “comments” field 729 wherein any information relevant to the diagnosis and repair of the problem(s) reported and/or found may be entered.

In addition to the above, add entry page 700 may also comprise “options” portion 717. In the embodiment of FIG. 7, “options” portion 717 comprises a list of options 730, 731, and 732, one or more of which may be selected by a user, e.g., by selecting with a pointing device the box appearing to the left of a particular option. In the embodiment of FIG. 7, upon selecting the box, an “X” appears in the box to signify that the option has been selected. In one embodiment, an option of “options” portion 717 need not be selected before the other information entered into add entry page 700 may be submitted to the log.

In the embodiment of FIG. 7, “options” portion 717 comprises “vital device information” option 730 whereby, if selected, vital device statistics information such as number of loads/unloads, when drives were last cleaned, hard/soft errors detected since last logged, numbers of gets/puts by a picker, etc., may be included in the detailed log entry when it is stored in the service log.

Another option that may be selected in the illustrated embodiment is “close service call at service center” option 731. If option 731 is selected, upon submission of the detailed log entry to EWS410, an internal flag of EWS 410 is set that tells EWS 410 to send an electronic mail containing at least a portion (in some embodiments, all) of the detailed log entry (or otherwise communicate at least a portion of the detailed log entry) to the service center computer system affiliated with the service personnel who participated in the service visit. In one of these embodiments, at the service center, the communicated portion of the detailed log entry is logged in a database and the service call is closed.

“Option” portions 717 may also comprise “escalate service call at service center” option 732. If such an option is selected, upon submission of the detailed log entry to EWS 410, an internal flag of EWS 410 is set that tells EWS 410 to send an electronic mail containing both at least a portion (in some embodiments, all of) the detailed log entry and the report page discussed earlier (or otherwise communicate at least a portion of the log entry and report page), along with some priority indication, to the service center computer system affiliated with the personnel who participated in the service visit. In such an instance, the communicated portion is logged at the service center and forwarded to the next higher level of support.

In some embodiments, add entry page 700 comprises default settings whereby certain information (e.g., the date and other information described above) may be autonomously entered into certain fields of add entry page 700 whenever add entry page 700 appears. In an alternative embodiment, rather than already being entered into add entry page 700 when add entry page 700 first appears, information (e.g., vital device statistics information or service call closure or escalation instructions) may be autonomously included in the log entry when the completed add entry page 700 is sent to EWS 410. In one embodiment, information is autonomously entered both when add entry page 700 first appears and when the information entered therein by an individual is sent to EWS 410. In some embodiments, these default settings may be configured by a user.

The above fields of add entry page 700 may be either required fields, optional fields, or some combination thereof, as these terms are understood by one of ordinary skill in the art. Upon completion of entering the requested data into any required fields, the service person, or other interested individual, may submit the completed entry page 700 (i.e., the detailed log entry) to EWS 410 for entry into the service log (e.g., into a data structure thereof) by selecting submit log entry button 718. Similar to the above, in one embodiment, after receiving the submitted information, EWS 410 alters (e.g., updates) the service log hosted thereby to include the received information. However, if at any time prior to submission the service person decides he or she does not want to submit the entry to EWS 410, the service person may terminate the information entry session by selecting cancel button 719.

It will be appreciated by one of ordinary skill in the art that the format of add entry page 700 is by way of example only, for add entry page 700 may have various configurations. For example, rather than comprising a single page, add entry page 700 may comprise a plurality of web-based pages, each web-based page providing one or more of the portions described above. Moreover, a fewer or greater number of portions than those depicted in FIG. 7 may be part of add entry page 700. In addition, the dimensions of the portions depicted in FIG. 7, as well as their arrangement, may be different from that depicted in FIG. 7.

In one embodiment, after selecting submit log entry button 718, an entry corresponding to the submitted detailed log entry is added to the entries of overview page 600. In some embodiments, the information contained in the newly-added entry of overview page 600 depends upon the arrangement of overview page 600. For example, in the embodiment of overview page 600 depicted in FIG. 6, each entry comprises the date a particular service visit was made, a brief description of at least one of the repairs performed on that visit (if any repairs were performed at all), and the name of at least one of the service persons who performed the repair(s). Therefore, in the illustrated embodiment, the newly-added entry of overview page 600 may comprise, under column 612, the date entered into date field 720; under column 614, at least one of the names (or initials) entered into service personnel field 723; and, under column 613, at least one of the parts entered into parts fields 724.

As discussed earlier, in one embodiment, a detailed log entry of the service log may be accessed by selecting the corresponding entry of overview page 600. In some embodiments, the format/arrangement of a detailed log entry is substantially similar to the template of add entry page 700 of FIG. 7. For example, a detailed log entry may comprise a date portion, a customer description portion, an actual problem description portion, a service personnel name(s) portion, a parts replaced portion, etc. However, unlike add entry page 700, the information for at least the required fields of page 700 may already appear in the detailed log entry. Moreover, in one embodiment, a detailed log entry does not have a portion that corresponds to options portion 717 of the embodiment of add entry page 700 of FIG. 7. Instead, the detailed log entry has a portion wherein vital device statistics information is provided and/or notification as to whether the service call was closed or escalated at the service center, depending upon which option(s) was selected in add entry page 700.

In addition, rather than including submit log entry button 718 and cancel button 719 (such as are included in the embodiment of add entry page 700 shown in FIG. 7), the detailed log entries may instead comprise an edit entry button, a return button, and/or a remove entry button. By selecting the edit entry button, in one embodiment, a cursor appears in one of the fields of the detailed log entry, and a submit edits button (not shown) appears in place of the edit entry button. The cursor may be moved to one or more fields whereby the particular information previously entered in the field(s) may be edited. An individual may then submit any edits to EWS 410 by selecting the submit edits button. On the other hand, by selecting the remove entry button, the entire detailed log entry may be erased from the service log. Furthermore, by selecting the return button, the detailed log entry may disappear and overview page 600 may reappear. In one embodiment, any editing or removal of submitted detailed log entries is password protected (e.g., via an administrative or service password).

Furthermore, the detailed log entries may comprise a “save entry” or “download entry” option (not shown) through which the service person or other individual may download the detailed log entry to the particular computer device used to access the service log or one or more storage devices communicatively coupled thereto, (e.g., download to customer computer device 102, to service person computer device 501, to service center computer system 502, etc.).

As can be seen from the above, in various embodiments of the present invention, information relating to the servicing of a processor-based device (e.g., storage device 104) may be entered, stored, reviewed, and/or edited through the above-discussed service log. It will be appreciated by one of ordinary skill in the art that the service log may comprise web-based pages other than those described above. Moreover, it will also be appreciated that the service log is not limited to processor-based devices that comprise a remote management card. Various embodiments of the present invention may be implemented with any processor-based device that may comprise an embedded web server.

Furthermore, various embodiments of the present invention alleviate the problems associated with the prior art. For example, in one embodiment, rather than having to service a device in an ad-hoc manner, a service person, as well as other individuals, will have a reviewable record of at least a portion of the service history of a processor-based device. Hence, the service person will have access to information that may be used in the diagnosis and/or repair of the current problem(s) occurring with the device. Moreover, because, in some embodiments, the service person will know of any previously unsuccessful attempts to fix the present problem(s), the service person will be influenced not to repeat such unsuccessful courses of action without a diligent determination that such steps should be repeated.

Also, because, in some embodiments, the service person may access the service log from any location on a data network to which the processor-based device on which the service log resides is communicatively coupled, in some embodiments, the service person may review the service log prior to visiting the device location. As a result, the service person may develop a preliminary idea of the source of the problem(s) before visiting the device. Moreover, the service person(s) may also develop a preliminary idea of the repairs that should be done to the device, and therefore, could make sure that he/she had the necessary equipment and replacement parts to perform such repairs before leaving to visit the device site.

Similarly, as discussed above, in one embodiment, the service person or other individual may request that the web server hosting the service log communicate the information entered into the service log to a service center computer system or other desired remote location, whereby the information may be stored, e g., in a database. Furthermore, in one embodiment, the service person, or other individual, may download the information entered into the log, e.g., to a disk of the service person's computer device. As a result, the person may later communicate the downloaded information to a database (e.g., a service center database) or print the information.

1. An application for providing at least a portion of the service history of a processor-based device, said application comprising:
code for receiving information relating to at least a portion of the service history of said processor-based device on which said application resides;
code for entering the received information into a data structure; and
code for providing at least one web-based page, said at least one web-based page comprising at least a portion of the information entered in said data structure.

2. The application of claim 1 wherein said processor-based device is a storage device.

3. The application of claim 2 wherein said storage device is a library.

4. The application of claim 1 wherein said application is part of a remote management card.

5. The application of claim 1 wherein said code for providing comprises code for providing said at least one web-based page to a location remote from said processor-based device.

6. The application of claim 5 wherein said receiving code is operable to receive said information from a location remote from said processor-based device, said remote location from which said information is received being a location selected from the group consisting of said location to which said at least one web page is provided and another remote location.

7. The application of claim 1 wherein said at least one web page further comprises an information entry means through which information may be entered into said at least one web page, said information entry means including an options portion.

8. The application of claim 7 wherein said options portion comprises at least one option selected from the group consisting of close service call at service center and escalate service call at service center.

9. The application of claim 1 wherein said application is operable to be accessed via a system administration application.

10. The application of claim 1 wherein said code for providing comprises:
code for providing an overview page wherein at least one entry of said overview page is a link to a detailed log entry.

11. A method for providing at least a portion of the service history of a processor-based device, said method comprising:
receiving information at said processor-based device relating to at least a portion of the service history of said processor-based device;
automatically entering the received information into a data structure; and
providing from said processor-based device at least one web-based page, said at least one web-based page comprising at least a portion of the information entered in said data structure.

12. The method of claim 11 wherein said processor-based device is a storage device.

13. The method of claim 11 wherein said providing step further comprises providing said at least one web-based page to a location remote from said processor-based device.

14. The method of claim 11 wherein said providing comprises providing an overview page wherein at least one entry of said overview page is a link to a detailed log entry.

15. The method of claim 11 further comprising:
communicating from said processor-based device at least a portion of said received information to a service center computer system.

16. A system for providing at least a portion of the service history of a processor-based device, said system comprising:
means for receiving at said processor-based device information relating to at least a portion of the service history of said processor-based device;
means for entering the received information into a data structure; and
means for providing from said processor-based device at least one web-based page, said at least one web-based page comprising at least a portion of the information entered in said data structure.

17. The system of claim 16 wherein said receiving means, storing means, and said providing means are part of a remote management card.

18. The system of claim 16 wherein said device further comprises:
means for communicating at least a portion of the received information to a service center computer system.

19. The system of claim 16 wherein said means for providing comprises:
means for providing an overview page wherein at least one entry of said overview page is a link to a detailed log entry.

20. The system of claim 16 wherein said receiving means and said providing means are accessible through a system administration application.
